(19) United States
(12) Patent Application Publication
(10) Pub. No.: US 2025/0327825 A1
(43) Pub. Date: Oct. 23, 2025

(54) An apparatus for chemical analysis and a method of adjusting the same

(71) Applicant: HTA S.r.l., Brescia (IT)

(72) Inventors: Giovanni Marchini, Brescia (IT); Enrico Marchini, Brescia (IT)

(21) Appl. No.: 18/860,641

(22) PCT Filed: Apr. 27, 2023
(86) PCT No.: PCT/IB2023/054348

§ 371 Date: Oct. 26, 2024

(30) Foreign Application Priority Data
May 6, 2022 (IT) 102022000009326

(51) Int. Cl. G01N 35/00; G01N 35/04; G01N 35/10

(52) U.S. Cl. CPC G01N 35/00712; G01N 35/1079; G01N 2035/0494

(57) ABSTRACT

An apparatus for chemical analysis includes an autosampler having a syringe and a needle coupled to one end of the syringe, the autosampler including a handling system for moving the syringe along an axis of longitudinal development. The apparatus for chemical analysis further includes a chemical analyzer having a septum disposed to close an introduction port of a sample in the chemical analyzer and shaped to be pierced and crossed by the needle of the syringe when it is moved by the handling system. The autosampler also includes a measurement sensor for measuring a distance travelled by the syringe over a predetermined time so as to compare the distance travelled by the syringe with a predetermined distance and identify an excessive tensioning of the septum.

### FIELD OF APPLICATION

The present invention applies to the technical field of devices for chemical analysis and, in particular, relates to an apparatus comprising an autosampler which can be coupled to chemical analyzers.

The present invention also relates to a method of adjusting a sampler for chemical analyzers.

### STATE OF THE ART

Due to technological and scientific developments, chemical analyses are today carried out using autosamplers that introduce a sample to be analyzed into a chemical analyzer.

Often this introduction is direct, i.e. the autosampler inserts the sample directly into the sample introduction port in the analyzer.

However, the relationship between the autosampler and the chemical analyzer often creates drawbacks. As is known, in fact, in the cases just mentioned the autosampler is equipped with a syringe with a needle adapted to pierce a septum positioned to close the sample introduction port in the analyzer. This septum is subject to wear and, after a certain number of perforations, it must be replaced. In this respect, it is secured in place by a septum holder which is screwed, typically manually by the laboratory technician, onto the sample introduction port in the analyzer. By screwing the septum holder, the septum is tensioned, therefore the more the user screws, the more the septum is tensioned.

However, it often happens that if the septum is tensioned too much, the syringe cannot pierce it and then inject the sample to be analyzed into the analyzer. Moreover, in more serious cases, the syringe is subjected to such a force that the needle bends. Conversely, when the resistance opposite from the septum placed under tension is less severe but in any case excessive, a coring of the septum itself can occur, resulting in parts of the septum breaking off and depositing residues inside the analyzer, thus polluting the analysis.

Moreover, the distance between the autosampler needle and the septum to be pierced may differ from case to case or the operating conditions of the autosampler may change over time (consider lubrication of the gears involved in moving the syringe). It follows that there is a need to repeatedly adjust the autosampler so that the needle or septum does not suffer the damage mentioned above.

### PRESENTATION OF THE INVENTION

The object of the present invention is to at least partially overcome the drawbacks highlighted above by providing a chemical analysis apparatus which allows the identification of incorrect septum tensioning.

In particular, an object of the present invention is to provide an apparatus for chemical analysis which allows adjusting the tensioning of the septum and therefore the resistance opposed by the same before damage occurs to the septum or to the needle of the syringe.

In fact, another object of the present invention is to provide an apparatus for chemical analysis that allows avoiding the flexion and/or breakage of the needle or the coring of the septum.

It follows that a further purpose of the present invention is to provide a chemical analysis apparatus that avoids pollution of the samples to be analyzed.

Moreover, another object of the present invention is to provide an apparatus for chemical analysis that allows a reduction in the costs caused by early replacement of the septum or needle as a result of the aforementioned events.

Said objects, as well as others which will become clearer below, are achieved by an apparatus for chemical analysis and a method of adjusting the same in accordance with the following claims, which are to be considered an integral part of the present patent.

In particular, the apparatus for chemical analysis comprises at least one autosampler having at least one syringe and at least one needle coupled to at least one end of the syringe itself, as well as handling means for moving the syringe along its axis of longitudinal development.

In addition, the chemical analysis apparatus comprises at least one chemical analyzer having at least one septum positioned to close at least one sample introduction port in the analyzer. In more detail, this sample introduction port typically consists of an access opening to the analyzer area into which the sample has to be inserted for analysis. As is the case with chemical analysis apparatuses of the prior art, the septum is shaped to be pierced and crossed by the syringe needle when the syringe is moved by the handling means.

According to one aspect of the invention, the autosampler comprises at least one measurement sensor for measuring a distance travelled by the syringe at least in a predetermined time.

Advantageously, the presence of the measurement sensor allows the distance travelled by the syringe to be compared with a predetermined distance.

This still advantageously allows the identification at least of excessive tensioning of the septum.

In fact, if in a predetermined time the syringe had to travel a certain distance and the syringe instead in the predetermined time has travelled a shorter distance, this means that the septum has opposed more resistance than should have been the case. This means that it has been tensioned too much.

Therefore, the aforementioned advantageously allows the tension of the septum to be adjusted and therefore the syringe to be prevented from bending or the septum from being pierced.

According to another aspect of the invention, moreover, the chemical analysis apparatus comprises an excessive force sensor on the syringe handling means.

Advantageously, this allows an emergency stop of the syringe handling means to be initiated if the septum is tensioned too much.

As a result, the excessive force sensor prevents bending or breakage of the needle.

Still advantageously, the aforementioned saves the costs incurred by replacement of the needle due to damage of the same.

From the above, it is evident that the above-mentioned objects and advantages are also achieved by an autosampler that can be operatively coupled to a chemical analyzer comprising:
at least one syringe having at least one needle coupled to at least one end of the syringe;
handling means for moving the syringe along a longitudinal development axis thereof;
at least one measurement sensor for measuring a distance travelled by the syringe at least at a predetermined time so as to compare the distance travelled by the syringe with a predetermined distance.

From the above, it is evident that the above-mentioned aims and advantages are also achieved by a method of adjusting an apparatus for chemical analysis comprising the following steps:
positioning the syringe in an initial position with respect to the septum;
moving the syringe towards the septum using the handling means for the predetermined time;
determining the distance travelled by the syringe in the predetermined time;
comparing the distance travelled with the predetermined distance.

### BRIEF DESCRIPTION OF THE DRAWINGS

Further features and advantages of the invention will become more apparent in light of the detailed disclosure of a preferred, but not exclusive, embodiment of an apparatus for chemical analysis, of an autosampler, and of a method for adjusting an apparatus for chemical analysis according to the invention, illustrated by way of example by means of the attached tables of drawings, wherein:

FIG. 1 depicts an apparatus for chemical analysis according to the invention in a sectional side view;

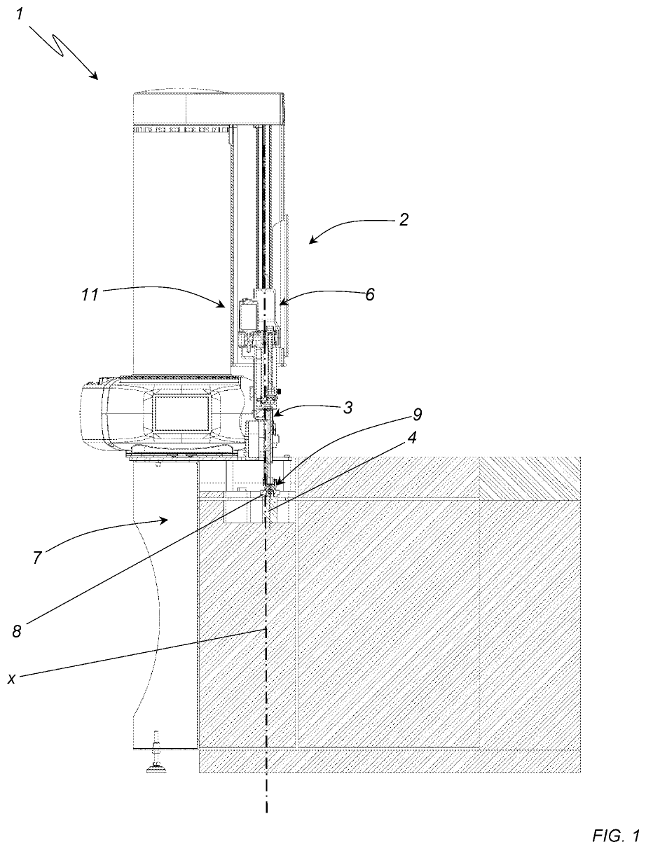

FIG. 2 depicts a block diagram of the method of adjusting according to the invention.

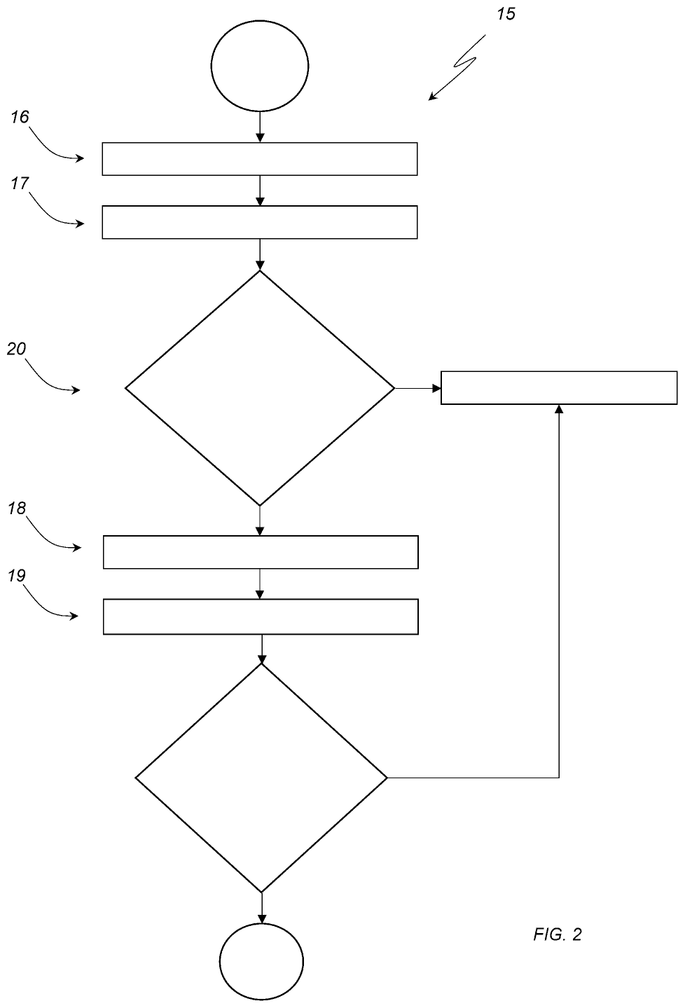

### DETAILED DESCRIPTION OF SOME PREFERRED EXAMPLE EMBODIMENTS

With reference to the cited figures, an apparatus 1 for chemical analysis according to the invention is described.

In particular, the apparatus 1 for chemical analysis comprises an autosampler 2 having, like the autosamplers of the prior art, a syringe 3 and a needle 4 coupled to one end thereof, as well as handling means 6 for moving the syringe 3 along its axis of longitudinal development x.

In addition, the apparatus 1 for chemical analysis also includes a chemical analyzer 7 having a septum 8 positioned to close a sample introduction port 9 in the analyzer 7.

As in the apparatuses for chemical analysis of the prior art, the septum 8 is shaped to be pierced and crossed by the needle 4 of the syringe 3 when the latter is moved by the handling means 6. Obviously, the type of chemical analyzer (which in the case shown in the figures is a gas chromatograph) can be any type without any limit for the present invention.

According to one aspect of the invention, the autosampler 2 comprises a measurement sensor 11 for measuring a distance travelled by the syringe 3 in a predetermined time.

Advantageously, the presence of the measurement sensor 11 allows the distance travelled by the syringe 2 over a certain period of time to be compared with a predetermined distance.

It follows, again advantageously, that an excessive or in any case an incorrect tensioning of the septum 8 be identified.

In fact, if in a predetermined time the syringe 3 should have travelled the predetermined distance and the syringe 3, on the other hand, in the predetermined time has travelled a shorter distance, it means that the septum 8 has opposed more resistance than should have been the case. This means that it has been tensioned too much.

Obviously, it is analogously possible to identify when the septum 8 is tensioned too little.

Advantageously, the aforementioned allows the septum 8 to be repositioned with the right tension.

In the embodiment described, this is made possible by the presence of a logical control unit, not shown in the figures, which allows the processing of data relating to the distance travelled and the time spent. Obviously, such a detail should not be considered limiting to the invention.

As far as the measurement sensor 11 is concerned, in the described embodiment it consists of an encoder coupled to the handling means 6. However, this detail should also not be considered as limiting for the invention as the measurement sensors can be implemented in any way.

According to another aspect of the invention, moreover, the chemical analysis apparatus 1 comprises, although not shown in the figures, an excessive force sensor on the handling means 6 of the syringe 3.

Advantageously, this allows it to be signaled when the handling means 6 require more energy so that the syringe 3 can pierce the septum 8, thus signaling an excessive tension of the latter.

Moreover, still advantageously, the foregoing allows an emergency stop of the handling means 6 of the syringe 3 to be commanded when the excessive force sensor is activated.

As a result, the excessive force sensor prevents bending or breakage of the needle 4.

Still advantageously, the above saves the costs incurred by replacement of the needle 4 due to early damage of the same.

According to a further aspect of the invention, the chemical analysis apparatus 1 comprises a feed variator of the handling means 6 of the syringe 3.

In particular, at each downward movement of the syringe 3, there is a first calibration section during which said control logic unit receives the distance travelled by the syringe 3 in a given time and, if it is lower or higher than the predetermined distance, the energy supplied to the handling means 6 is increased or reduced so that the syringe 3 reaches said predetermined speed. Obviously, this feature should not be considered limiting for different forms of the invention according to which calibration is carried out on a one-off basis.

In any case, the presence of the variator allows, advantageously, varying the speed of the syringe 3 from time to time and therefore, advantageously, moving the syringe 3 always at the predetermined speed, regardless of any slowdowns due to the condition of the gears of the handling means 6, such as, for example, a lower lubrication thereof due to the prolonged use of the autosampler 2.

It follows once again that, advantageously, the detection of a possible incorrect tensioning of the septum 8 is made independent of false reports deriving from variations in the operating conditions of the apparatus 1 of the invention.

Moreover, the aforementioned allows the autosampler 2 to be made versatile and therefore usable not only in the apparatus 1 of the invention.

In fact, as mentioned above and as anticipated, it is evident that the object of the invention is also, although not represented herein, an autosampler having the same characteristics as those disclosed above and can be coupled to any chemical analyzer or to sample containers arranged in series.

This is possible thanks to the presence of both the measurement sensor and the speed variator.

Obviously, a precise description of the autosampler is avoided here since it is a repetition of what has already been described above.

Operatively, the apparatus 1 for chemical analysis is adjusted by an appropriate adjustment method 15. In particular, the method 15 of the invention comprises a step of placing 16 the syringe 3 in an initial position with respect to the septum 8, followed by a step of moving 17 the syringe 3 towards the septum 8 through the handling means 6 for the predetermined time. According to one aspect of the invention, the method 15 comprises a step of determining 18 the distance travelled by the syringe 3 in the predetermined time and, therefore, a step of comparing 19 the distance travelled with the predetermined distance.

Advantageously, this allows verifying that the syringe 3 travels the predetermined distance in the predetermined time and, therefore, that the septum 8 is correctly positioned on the introduction port 9 located on the chemical analyzer 7. Otherwise, the aforementioned allows the septum 8 to be adjusted with the correct tension in an advantageous manner.

Moreover, according to another aspect of the invention, the method 15 comprises, after the comparison step 19, a step of reporting any differences between the distance travelled by the syringe 3 and the predetermined distance. In particular, this report is obtained with the logical control unit which, by means of a computer product stored in the same, processes the aforementioned data and, where appropriate, reports the aforementioned difference.

Moreover, according to a further aspect of the invention, the method 15 comprises, during the movement step 17, a possible stopping step 20 of the handling means 6 in case of activation of the excessive force sensor.

Advantageously, the above allows the movement of the syringe 3 to be stopped and prevents the needle 4 from straining to pierce the septum 8.

It follows, again advantageously, that the stopping step 20 allows the needle 4 to be preserved from the aforementioned damages.

Moreover, this advantageously saves the costs incurred by early replacement of the needle 4.

According to another aspect of the invention, the method 15 comprises a calibration step. This comprises, in turn, a step of applying an initial feed to the handling means 6 of the syringe 3, followed by a step of moving the syringe 3 towards the septum 8.

According to a further aspect of the invention, in particular, the calibration step comprises a step of varying the initial feed to the handling means 6.

In this way, advantageously, it is possible to correct the speed of movement of the syringe 3 so that it is moved with the predetermined speed.

Advantageously, this allows the movement speed of the syringe 3 to be made independent of any slowdowns due to the condition of the gears of the handling means 6, such as, for example, a lower lubrication thereof due to prolonged use of the autosampler 2.

Still advantageously, the above allows verifying that the syringe 3 travels the predetermined distance in the predetermined time.

It follows once again that, advantageously, the detection of a possible incorrect tensioning of the septum 8 is made independent of false reports deriving from variations in the operating conditions of the apparatus 1 of the invention.

On closer inspection, the calibration step can be carried out once at the first start of the chemical analysis apparatus 1, or at predetermined intervals. The aforementioned, however, does not constitute any limitation to the present invention. In fact, the calibration step, according to other embodiments, can be carried out continuously until the apparatus and/or the autosampler is in action. In any case, it is clear that, in order for the calibration step to fulfil its function, it must be carried out at the latest at the beginning of the moving step 17.

In light of the foregoing, it is understood that the apparatus for chemical analysis according to the invention achieves all the intended purposes.

In particular, the apparatus for chemical analysis allows an incorrect tensioning of the septum to be identified.

Accordingly, it allows the tensioning of the septum, and therefore the resistance opposed by the septum, to be adjusted before damage occurs to the septum or needle of the syringe.

Moreover, the chemical analysis apparatus allows the bending and/or breakage of the needle or the coring of the septum to be avoided.

It follows that the chemical analysis apparatus according to the invention makes it possible to avoid contamination of the samples to be analyzed.

In addition, it allows reduction of the costs caused by the early replacement of the septum or needle as a result of the aforementioned events.

The invention is subject to numerous modifications and variations, all falling within the appended claims. Moreover, all the details may furthermore be replaced by other technically equivalent elements, and the materials may be different if required, without departing from the scope of protection of the invention defined by the appended claims.

The invention claimed is:

1. An apparatus for chemical analysis comprising:
an autosampler having a syringe and a needle coupled to an end of said syringe, said autosampler also comprising handling means for moving said syringe along an axis of longitudinal development of said syringe; and
a chemical analyzer having a septum positioned to close an introduction port of a sample in said chemical analyzer, said septum being shaped to be pierced and crossed by said needle of said syringe when said syringe is moved by said handling means,
wherein said autosampler comprises a measurement sensor of a distance travelled by said syringe at least in a predetermined time so as to compare said distance travelled by said syringe with a predetermined distance, and to identify at least an excessive tensioning of said septum.

2. The apparatus for chemical analysis according to claim 1, further comprising a feed variator of said handling means so that said syringe is moved with a predetermined speed.

3. The apparatus for chemical analysis according to claim 1, further comprising an excessive force sensor of said handling means of said syringe.

4. An autosampler configured to be operatively coupled to a chemical analyzer and comprising:
a syringe having a needle coupled to an end of said syringe;
handling means for moving said syringe along an axis of longitudinal development of said syringe; and
a measurement sensor measuring a distance travelled by said syringe at least in a predetermined time in order to compare said distance travelled by said syringe with a predetermined distance.

5. The autosampler according to claim 4, further comprising a variator for feeding said handling means so that said syringe is moved with a predetermined speed.

6. The autosampler according to claim 4, further comprising an excessive force sensor of said handling means of said syringe.

7. A method for adjusting an apparatus for chemical analysis according to claim 1, said method comprising:
positioning said syringe in an initial position with respect to said septum;
moving said syringe towards said septum by said handling means for said predetermined time;
determining said distance travelled by said syringe in said predetermined time; and
comparing said distance travelled with said predetermined distance.

8. The method according to claim 7, further comprising, after the step of comparing, a step of reporting any differences between said distance travelled and said predetermined distance.

9. The method according to claim 7, further comprising a calibration step, comprising:
applying an initial power supply to said handling means;
moving said syringe towards said septum; and
varying said initial power supply so that said syringe is moved with said predetermined speed.

10. The method according to claim 7, wherein the apparatus comprises an excessive force sensor of said handling means, further comprising, during the step of moving, an emergency stop step of said handling means in case of activation of said excessive force sensor.
